(19) United States
(12) Patent Application Publication
(10) Pub. No.: US 2022/0183225 A1
(43) Pub. Date: Jun. 16, 2022

(54) KIT FOR CONVERTING GRASS TRIMMER TO LAWNMOWER

(71) Applicant: Wu Lin Xiang, Yongkang (CN)

(72) Inventor: Wu Lin Xiang, Yongkang (CN)

(21) Appl. No.: 17/123,152

(22) Filed: Dec. 16, 2020

(51) Int. Cl. A01D 34/68; A01D 34/74

(52) U.S. Cl. CPC A01D 34/68; A01D 2101/00; A01D 34/74

(57) ABSTRACT

A kit for converting trimmer to lawnmower is disclosed. The kit comprises blade stand, edge support and variety of blades and strings. The kit is compatible with all the existing grass trimmers present in market. In an embodiment of the present invention, the user can easily adjust the cutting height by adjusting the height of blade stand on the edge support. In an embodiment of the present invention, the blade stand comprise of edge support that is an aluminum or steel loop structure to provide wide variety of height levels to blade stand for cutting brushes. The blade stand and edge support comprise of holes drilled in them such that blade stand can be screwed to edge support at variety of height levels.

### FIELD OF THE INVENTION

The present invention relates to a kit for grass trimmer and more particularly to a kit that converts the existing grass trimmer into a push-type lawnmower in minutes.

### BACKGROUND OF THE INVENTION

The main difference between grass trimmer and lawnmower relates to the difference in capabilities. The grass cutter and lawnmower have different abilities. For instance, the lawnmowers are more powerful and efficient. Trying to manage the whole lawn using a grass cutter is cumbersome. Moreover, when a person uses a grass cutter around trees, there is a high chance that the blades will be damaged. There are some areas where the lawnmowers cannot access; nevertheless, the grass cutters can easily access some of these regions, including the border-line.

Taking care of the lawn means that it should be trimmed and mowed regularly. But for these two activities a user has to buy a grass trimmer and lawnmower separately which becomes very costly to user to buy and maintain.

Several prior attempts to deal with such problems have been utilized as set forth below.

United States Patent Publication No US20050044834A1 to Appleyard et. al. discloses a lawnmower modified to incorporate grass trimmer. A first embodiment provides a slot on one sidewall of the lawnmower deck for providing space for the trimmer string to protrude above the mower blade. The second embodiment provides rotation of a tilted grass trimmer unit by a belt drive assembly including a belt tensioner that works off the rotation of the lawnmower's power shaft. The grass trimmer unit is located outside the lawnmower deck at the left front corner of the deck and tilted towards the deck. A third embodiment positions a belt driven grass trimmer unit at the left front corner of the deck, and includes a belt tensioner unit below the deck.

United States Patent Publication No. US6779325B1 to Robillard et. Al. discloses An edging and trimming assembly for use with a lawn mower includes a flexible shaft extending through a hollow arm with the arm being connected to a mower deck through a hub for pivotal movement of the arm. A gear train is connected to the lawn mower's power driven rod and is selectably coupled to one end of the flexible shaft for selectable rotation thereof. A trimmer head is attached to an opposed end of the flexible shaft and includes a cutter for cutting grass upon rotation of the trimmer head. A linkage extends between the arm and the trimmer head for adjusting the trimmer head between horizontal and vertical cutting planes. The linkage enables the trimmer head to move between selectable angular configurations. A shield member is rotatably coupled to the flexible shaft for surrounding the trimmer head and defines an opening through which the cutting member extends.

United States Patent Publication No. US20150040529A1 to Standridge et. Al. discloses a weed and grass trimmer attachment and riding mowers having weed and grass trimmer attachments are provided. The trimmer attachment attaches to a riding mower using a structural support arm and a mounting member. The trimmer attachment takes power from the mower drive shaft to operate a trimmer attachment. The trimmer attachment includes a floating trimmer shaft that compensates for ground variations. The trimmer attachment enables a seated operator to both mow a lawn and trim grass and weeds.

There is accordingly a need for an invention that provide an easy to install kit that when used on existing grass trimmer convert it into a push type lawnmower thus eliminating the need for a user to invest in separate lawnmower.

### SUMMARY OF THE INVENTION

In an embodiment of the present invention, a kit for converting grass trimmer into a push-type lawnmower is disclosed.

In an embodiment of the present invention, the kit can enable the grass trimmer to mow, trim and even edge to help a user's lawn look beautiful.

In an embodiment of the present invention, the user can easily adjust the cutting height from 1.3 inches to 3.8 inches tall thus making sure the grass in the lawn is at the same height as desired by the user.

In an embodiment of the present invention, the kit comprise blade holder, set of different type of blades and screws to install the kit to convert grass trimmer to lawnmower.

In an embodiment of the present invention, the brush cutter blade stand convert comes with a perfect design that makes it compatible with various types of grass blades and strings available in the market.

It is an object of the present invention to provide a kit that converts the grass trimmer to lawnmower thus eliminating the need for a user to invest in a separate lawnmower.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1 illustrates an exemplary embodiment of the present invention;

FIG. 2 illustrates an exemplary embodiment of the brush cutter blade stand adjusted at the lowest height;

FIG. 3 illustrates an exemplary embodiment of the brush cutter blade stand adjusted at the medium height;

FIG. 4 illustrates an exemplary embodiment of the brush cutter blade stand adjusted at the taller height;

FIG. 5 illustrates an exemplary embodiment of the brush cutter blade stand adjusted at the tallest height;

FIG. 6 illustrates an exemplary embodiment of the brush cutter blade stand adjusted at another taller height;

FIG. 7 illustrates an exemplary embodiment of the present invention describing various types of grass blades that comes with the kit;

FIG. 8 illustrates an exemplary embodiment of the present invention wherein the kit is used with the existing grass trimmer to convert into a lawnmower.

### DETAILED DESCRIPTION OF THE INVENTION

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

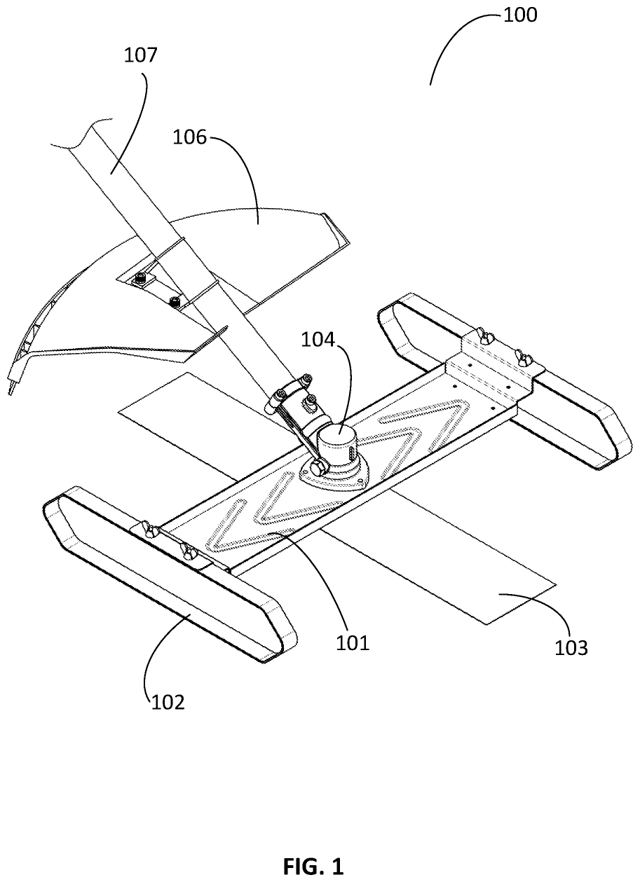

With reference now to the drawings, and in particular to FIG. 1 to FIG. 8 thereof, a new water enhancer and refiner embodying the principles and concepts of the present invention is described.

In an embodiment of the present invention, the kit for converting grass trimmer to lawnmower comprises: a blade stand, an edge support, different type of blades and strings and driverless screws.

FIG. 1 illustrates an exemplary embodiment of the present invention, wherein the grass trimmer comprises a shaft 107 pivotally attached to the gear case or cutting swath 104. In order to convert grass trimmer to lawnmower the blade stand 101 is attached to the gear case 104 and the blade 103 is rotatably mounted on the gear case 104 which consists of motor that rotates the blade or string when required.

In an embodiment of the present invention, the blade stand 101 comprise of edge supports 102 on both side of the blade stand, that is an aluminum or steel loop structure configured to provide variety of height levels to the blade stand for cutting brushes.

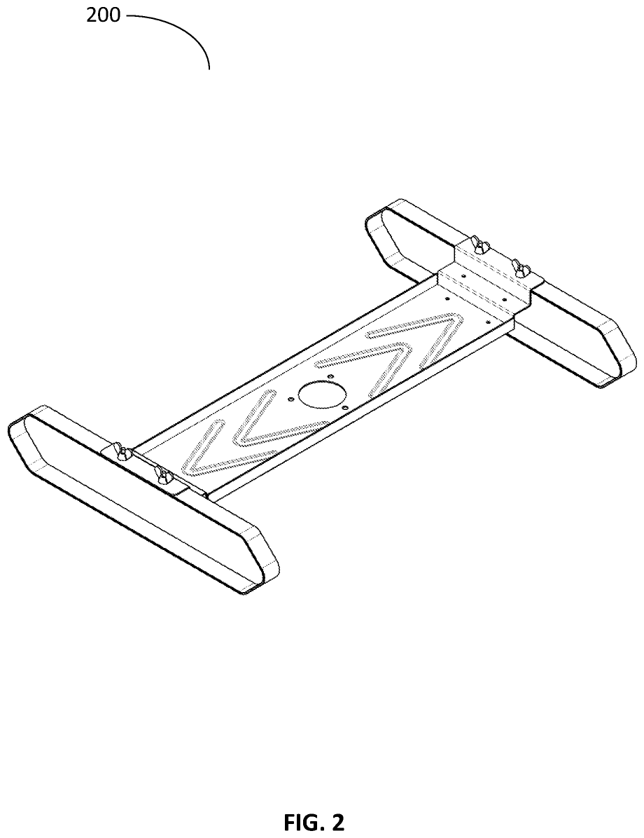

In an embodiment of the present invention, the blade stand 101 and its edge support 102 comprise of holes drilled in them such that blade stand 104 can be screwed to edge support 102 in wide variety of heights and orientations as discussed in FIGS. 2 to 6.

In all the grass trimmers present in the market, the shaft 107 is provided with debris shield 106 to protect a user from flying debris.

In an embodiment of the present invention, the kit provided with this invention is compatible with all the existing grass trimmers in market.

FIG. 2 illustrates an embodiment 200 of the present invention, wherein the blade stand is mounted at the lowest height on the edge support

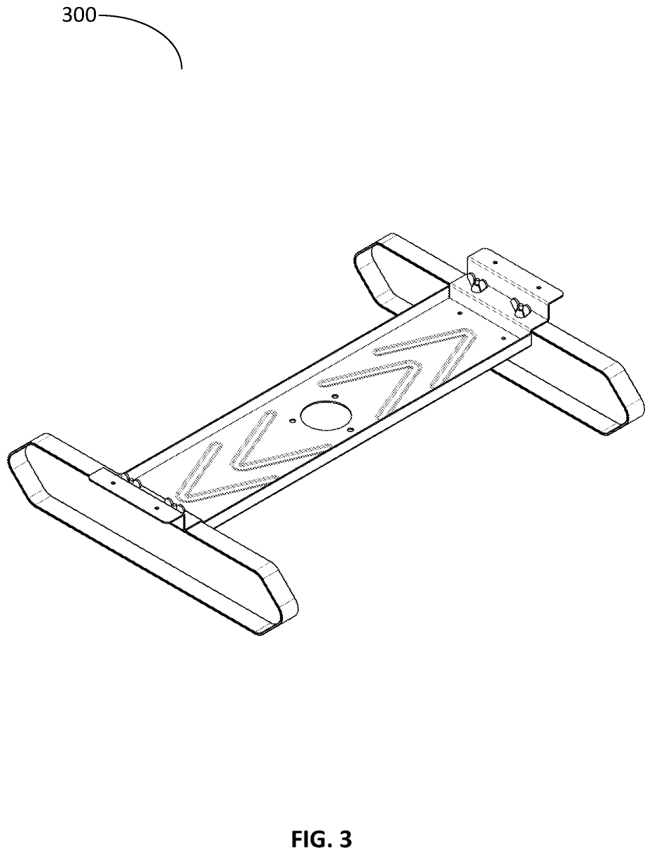

FIG. 3 illustrates an embodiment 300 of the present invention, wherein the blade stand is mounted at medium height on the edge support.

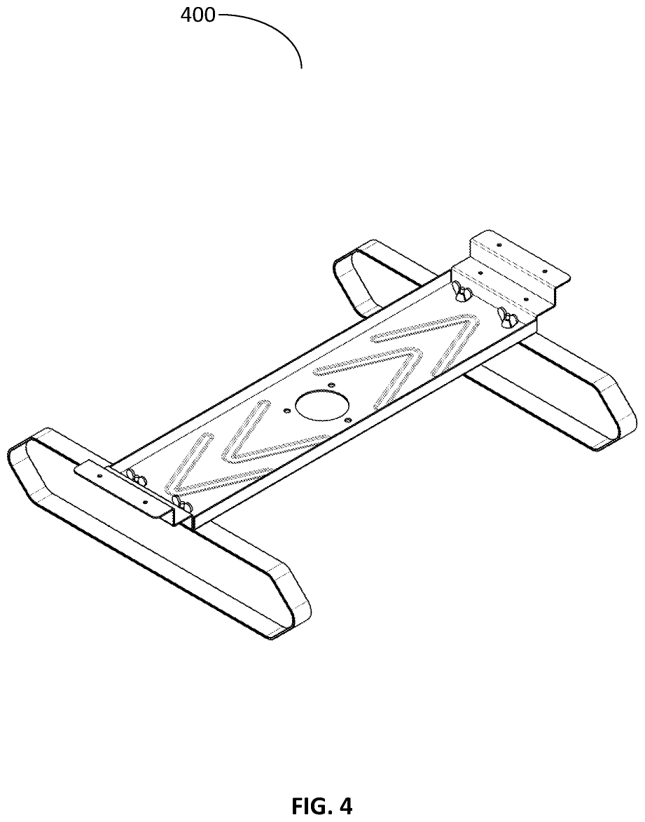

FIG. 4 illustrates an embodiment 400 of the present invention, wherein the blade stand is mounted taller height on the edge support.

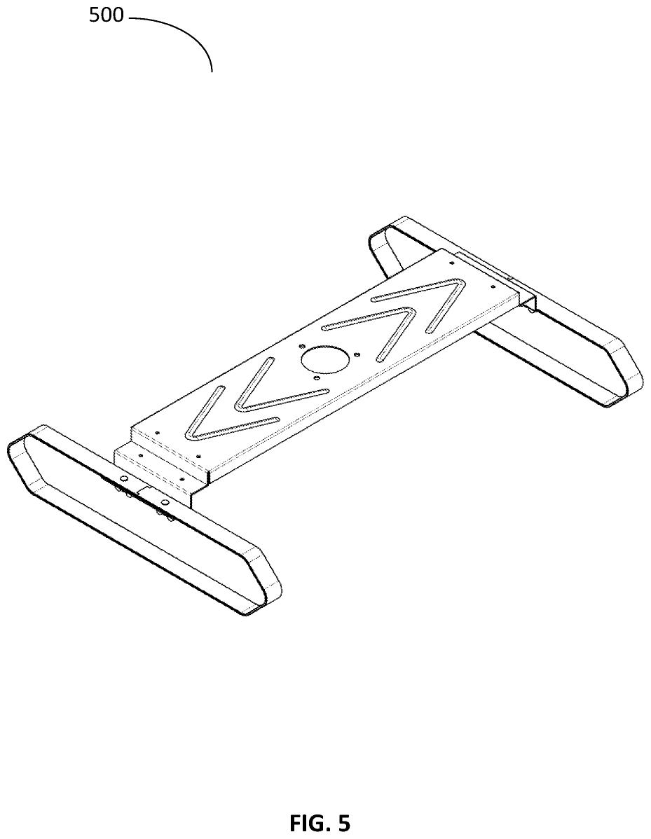

FIG. 5 illustrates an embodiment 500 of the present invention, wherein the blade stand is mounted at the tallest height on the edge support.

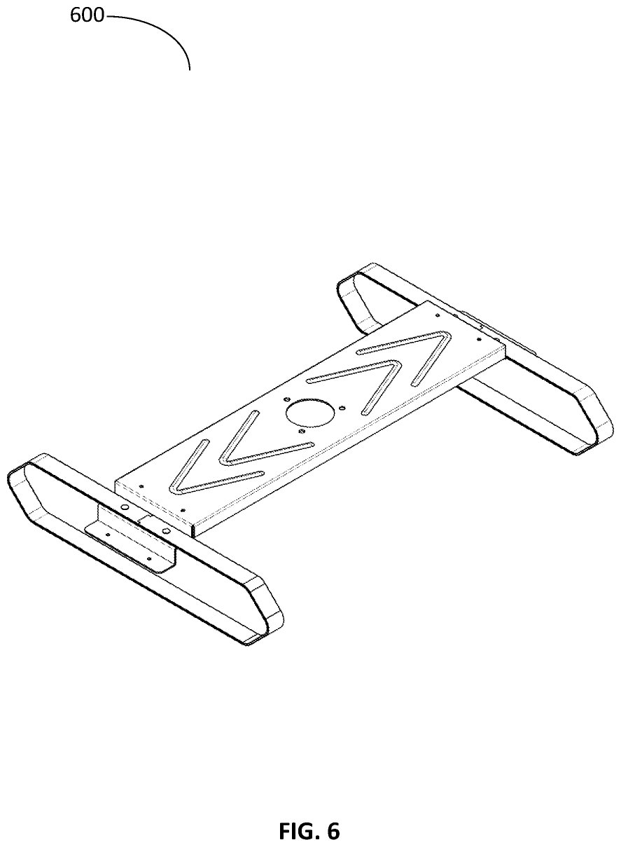

FIG. 6 illustrates an embodiment 600 of the present invention, wherein the blade stand is mounted at a taller height on the edge support

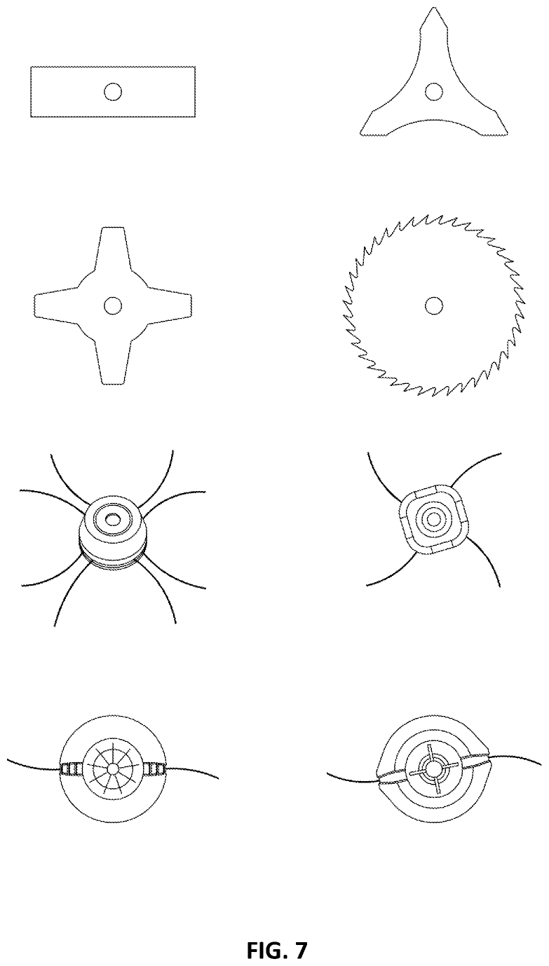

FIG. 7 illustrates an embodiment of the present invention describing various blades and strings that are compatible with the blade stand and all grass trimmers.

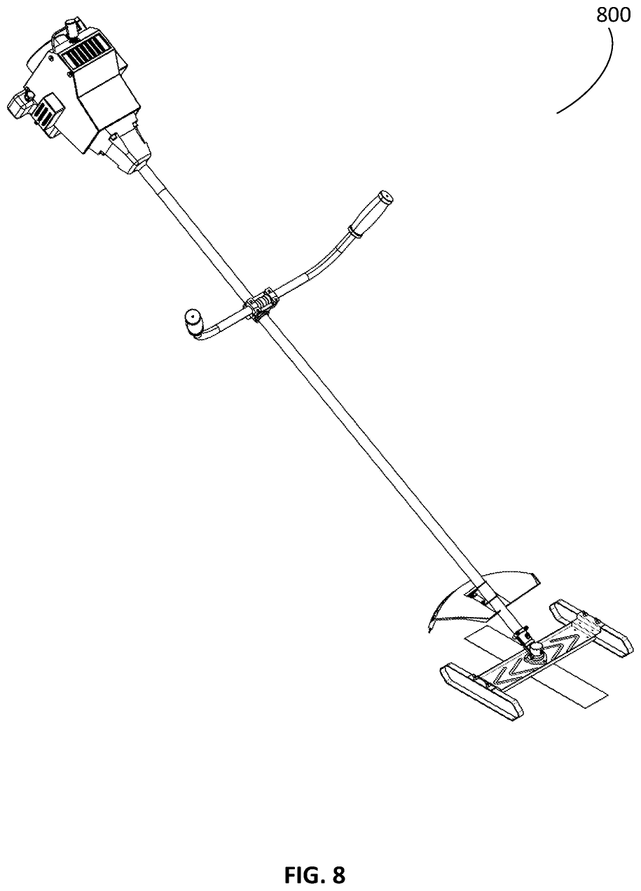

FIG. 8 illustrates an embodiment 800 of the present invention wherein the existing grass trimmer is now converted to a push type lawnmower 800 after installing the kit.

By virtue of implementing the above embodiments, the invention provides a kit that converts a grass trimmer to lawn mower thus eliminating the need of investing in a separate lawnmower.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein—and in particular embodiment specifically contemplated, is intended to be practiced in the absence of any element which is not specifically disclosed herein.

1. A kit for converting user's grass trimmer to lawnmower comprising:
a blade stand;
a pair of edge support;
variety of blades and strings;
driverless screws.

2. A generic grass trimmer of user according to claim 1 comprising a gearcase, shaft and motor wherein the gear case is pivotally mounted on one end of shaft and motor is attached to the other end of the shaft.

3. A kit for converting grass trimmer to lawnmower according to claim 1, wherein the blade stand is attached to the gear case and blades are rotatably mounted on the gear case which consist of motor that rotates the blade or string when required.

4. A kit for converting grass trimmer to lawnmower according to claim 1, wherein the blade stand comprises edge support on both sides to provide a height for cutting the brushes.

5. A kit for converting grass trimmer to lawnmower according to claim 1, wherein the blade stand and edge support comprises holes drilled in them such that blade stand can be screwed and configured on edge support in wide variety of heights and orientations.
